(19) United States
(12) Patent Application Publication
(10) Pub. No.: US 2018/0321357 A1
(43) Pub. Date: Nov. 8, 2018

(54) RADOME FOR RADAR SENSOR IN A VEHICLE, METHOD OF MANUFACTURING THE RADOME, RADAR SENSOR INCLUDING THE RADOME, AND METHOD OF MANUFACTURING THE RADAR SENSOR

(71) Applicant: MANDO CORPORATION, Pyeongtaek-si (KR)

(72) Inventor: Woo-Young KIM, Hwaseong-si (KR)

(21) Appl. No.: 15/969,282

(22) Filed: May 2, 2018

(30) Foreign Application Priority Data
May 2, 2017 (KR) 10-2017-0056361

(51) Int. Cl. G01S 7/28; G01S 13/93; H01Q 1/42; H01Q 1/32

(52) U.S. Cl. CPC G01S 7/2813; G01S 13/931; G01S 2007/027; H01Q 1/3233; H01Q 1/42

(57) ABSTRACT

Disclosed herein are a radome for a radar sensor in a vehicle, a method of manufacturing the radome, and a radar sensor comprising the radome. The radome for a radar sensor in a vehicle, the method of manufacturing the radome, and the radar sensor comprising the radome include: a radome configured to a first region to penetrate a transmission signal and a second region to penetrate a reception signal; and a depression formed in a side of the radome material facing a position from which the transmission signal is transmitted, among sides of the radome material.

### CROSS-REFERENCE TO RELATED APPLICATION

This application is based on and claims priority under 35 U.S.C. § 119 to Korean Patent Application No. 10-2017-0056361, filed on May 2, 2017, in the Korean Intellectual Property Office, the disclosure of which is incorporated by reference herein in its entirety.

### BACKGROUND

### 1. Field

The present disclosure relates to a radome for radar sensor in a vehicle, a method of manufacturing the radome, a radar sensor including the radome, and a method of manufacturing the radar sensor.

### 2. Description of the Related Art

In general, a typical radome is a cover that covers a radar antenna to reduce wind pressure applied on the radar antenna or to prevent jamming due to deteriorating weather conditions, such as snow or rain.

The typical radome is provided for a radar, and the radar emits electromagnetic waves using a main lobe and side lobes of a directional beam antenna pattern.

For example, Korean Patent Registration No. 10-1175745, filed on Aug. 14, 2012, discloses a vehicle radar apparatus for detecting the rear using a main lobe and grating lobes and a detecting method thereof, wherein the main lobe and the grating lobes are radiated according to the corresponding frequencies through time slots.

However, the vehicle radar apparatus for detecting the rear using the main lobe and the grating lobes and the detecting method thereof had limitations in minimizing signal interference due to the grating lobes while maximizing the main lobe.

Accordingly, recently, studies on a radome for minimizing signal interference due to side lobes while maximizing a main lobe, a method of manufacturing the radome, a radar including the radome, and a method of manufacturing the radar are conducted consistently.

Korean Patent Registration No. 10-117545 (Aug. 14, 2012)

### SUMMARY

Therefore, it is an aspect of the present disclosure to provide a radome capable of minimizing signal interference due to side lobes while maximizing a main lobe, a method of manufacturing the radome, a radar including the radome, and a method of manufacturing the radar.

Additional aspects of the disclosure will be set forth in part in the description which follows and, in part, will be obvious from the description, or may be learned by practice of the disclosure.

In accordance with an aspect of the present disclosure, a radome may include, a radome material configured to prevent a transmission signal and a reception signal from being damaged; and a depression formed in a side of the radome material facing a position from which the transmission signal is transmitted, among sides of the radome material.

In accordance with another aspect of the present disclosure, a radome may include, a radome material configured to prevent a transmission signal and a reception signal from being damaged; and a protrusion formed in the other side of the radome material facing a position from which the transmission signal is transmitted, among sides of the radome material.

Further, a radome may comprise a protrusion formed in the other side of the radome material facing between the position from which the transmission signal is transmitted and a position at which the reception signal is received, among the sides of the radome material.

Further, the depression may be formed in a curved shape.

Further, the protrusion may be formed in a convex shape.

In accordance with an aspect of the present disclosure, a radar comprising a radome may comprise: a body; a Printed Circuit Board (PCB) mounted on the body, and including a transmitter configured to transmit a transmission signal for sensing an object, and a receiver configured to receive a reception signal for sensing the object; a radome material coupled with the body and configured to prevent the transmission signal and the reception signal from being damaged; and a depression formed in a side of the radome material facing a position from which the transmission signal is transmitted, among sides of the radome material.

In accordance with another aspect of the present disclosure, a radar comprising a radome may comprise: a body; a Printed Circuit Board (PCB) mounted on the object, and including a transmitter configured to transmit a transmission signal for sensing an object, and a receiver configured to receive a reception signal for sensing the object; a radome material; and a protrusion formed in the other side of the radome material facing between a position from which the transmission signal is transmitted and a position at which the reception signal is received, among sides of the radome material.

Further, the depression may be formed in a curved shape.

Further, the protrusion may be formed in a convex shape.

In accordance with an aspect of the present disclosure, a method of manufacturing a radar may comprise: preparing a body; mounting a Printed Circuit Board (PCB) on the body; forming a transmitter configured to transmit a transmission signal for sensing an object, on a side of the PCB, and forming a receiver configured to receive a reception signal for sensing the object, on the other side of the PCB; preparing a radome material configured to prevent the transmission signal and the reception signal from being damaged; forming a depression in a side of the radome material facing a position from which the transmission signal is transmitted, among sides of the radome material; and coupling the radome material in which the depression is formed, with the body.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view showing an example of a radome according to an embodiment of the present disclosure.

FIG. 2 is a cross-sectional view showing another example of a radome according to an embodiment of the present disclosure.

FIG. 3 is a cross-sectional view showing another example of a radome according to an embodiment of the present disclosure.

FIG. 4 is a flowchart illustrating an example of a method of manufacturing a radome according to an embodiment of the present disclosure

FIG. 5 is a flowchart illustrating another example of a method of manufacturing a radome, according to an embodiment of the present disclosure.

FIG. 6 is a flowchart illustrating another example of a method of manufacturing a radome according to an embodiment of the present disclosure.

FIG. 7 is a cross-sectional view showing an example of a radar including a radome according to an embodiment of the present disclosure

FIG. 8 shows a directional beam antenna pattern transmitted from a transmitter of a typical radar, and a directional beam antenna pattern transmitted from a transmitter of a radar according to the present disclosure.

FIG. 9 is a cross-sectional view showing another example of a radar including a radome according to an embodiment of the present disclosure

FIG. 10 is a cross-sectional view showing another example of a radar including a radome according to an embodiment of the present disclosure.

FIG. 11 is a flowchart illustrating an example of a radar manufacturing method according to an embodiment of the present disclosure

FIG. 12 is a flowchart illustrating another example of a radar manufacturing method according to an embodiment of the present disclosure.

FIG. 13 is a flowchart illustrating another example of a radar manufacturing method according to an embodiment of the present disclosure.

### DETAILED DESCRIPTION

Hereinafter, the embodiments of the present disclosure will be described in detail with reference to the accompanying drawings. The following embodiments are provided to transfer the technical concepts of the present disclosure to one of ordinary skill in the art. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

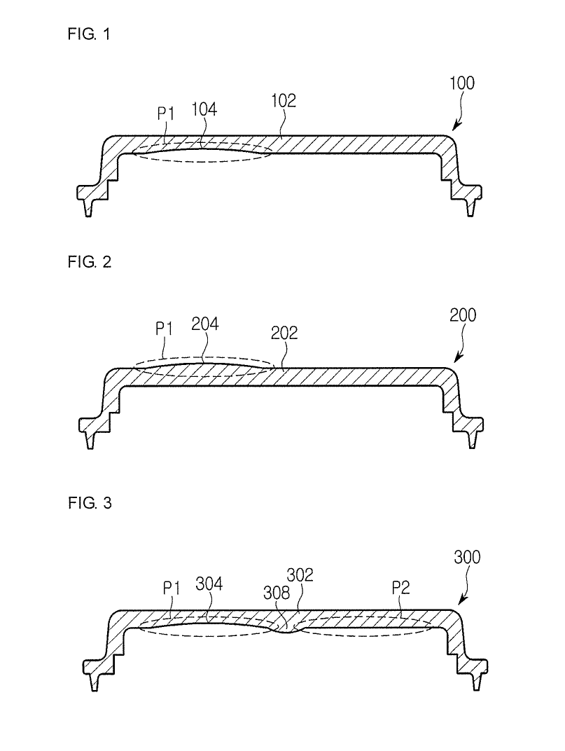

FIG. 1 is a cross-sectional view showing an example of a radome according to an embodiment of the present disclosure, and FIG. 2 is a cross-sectional view showing another example of a radome according to an embodiment of the present disclosure.

FIG. 3 is a cross-sectional view showing another example of a radome according to an embodiment of the present disclosure.

Referring to FIGS. 1 to 3, a radome 100 to 300 according to an embodiment of the present disclosure may include a radome material 102 to 302 and a depression 104 to 304.

The radome material 102 to 302 may prevent a transmission signal and a reception signal from being damaged.

As shown in FIG. 1, the depression 104 may be formed in a side of the radome material 102 facing a position P1 from which the transmission signal is transmitted, among sides of the radome material 102.

For example, the depression 104 may be formed in a curved shape.

As shown in FIG. 2, a protrusion 204 may be formed in the other side of the radome material 202 facing the position P1 from which the transmission signal is transmitted.

The protrusion 204 may be formed in a convex shape.

As shown in FIG. 3, the radome 300 according to an embodiment of the present disclosure may further include a protrusion 308.

The protrusion 308 may be formed in the other side (of the radome material 302 facing between the position P1 from which the transmission signal is transmitted and a position P2 at which a reception signal is received, among the sides of the radome material 302.

For example, the protrusion 308 may be formed in a curved shape.

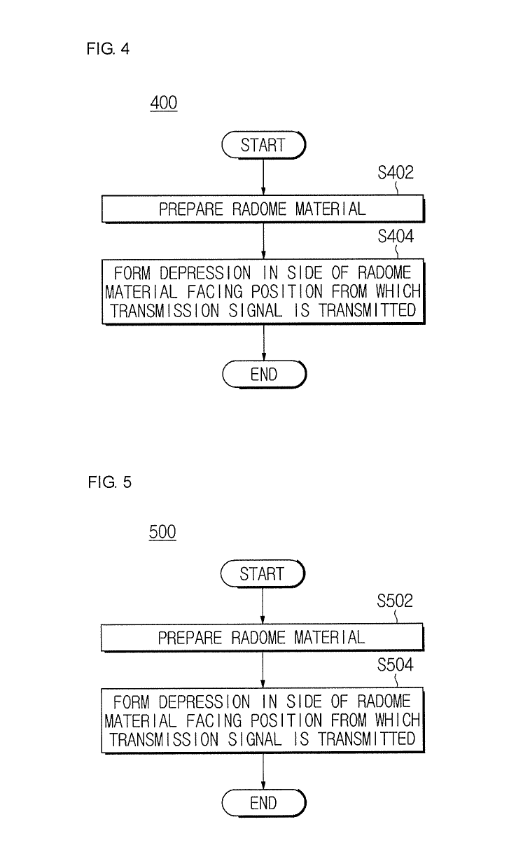

Hereinafter, a method of manufacturing the radome 100 to 300 according to an embodiment of the present disclosure will be described with reference to FIGS. 4 to 6.

FIG. 4 is a flowchart illustrating an example of a method of manufacturing a radome according to an embodiment of the present disclosure, and FIG. 5 is a flowchart illustrating another example of a method of manufacturing a radome, according to an embodiment of the present disclosure.

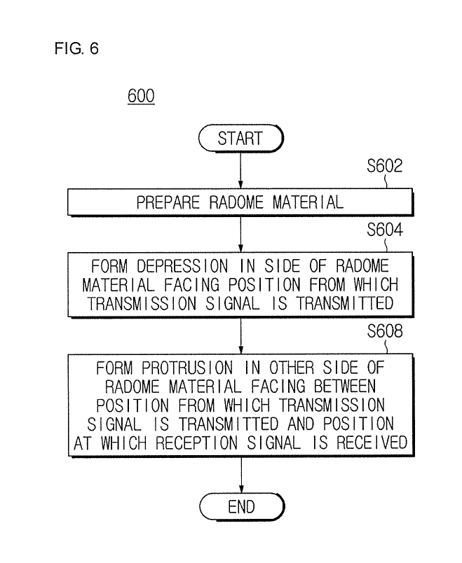

FIG. 6 is a flowchart illustrating another example of a method of manufacturing a radome according to an embodiment of the present disclosure.

Referring to FIGS. 4 to 6, a method 400 to 600 of manufacturing a radome according to an embodiment of the present disclosure may include operation S402 to S602 of preparing a radome material, and operation S404 to S604 of forming a depression or a protrusion.

In operation S402 to S602 of preparing a radome material, a radome material (102, 202, and 302 of FIGS. 1 to 3) for preventing a transmission signal and a reception signal from being damaged may be prepared.

Thereafter, in operation S404 to S604 of forming a depression or a protrusion, a depression (104, 204, or 304 of FIGS. 1 to 3) may be formed in a side of the radome material (102, 202, and 302 of FIGS. 1 to 3) facing a position (P1 of FIGS. 1 to 3) from which the transmission signal is transmitted, among sides of the radome material (102, 202, and 302 of FIGS. 1 to 3).

However, in operation S504 of forming a protrusion, as shown in FIG. 5, a protrusion may be formed on the other side of the radome material 202 facing the position P1 from which the transmission signal is transmitted, among the sides of the radome material 202.

Also, for example, in operation S404 to S604 of forming the depression, the depression (104 and 304 of FIGS. 1 and 3) may be formed in a curved shape, and in operation S504 of forming the protrusion, the protrusion 204 may be formed in a convex shape.

As shown in FIG. 6, the method 600 of manufacturing the radome according to an embodiment of the present disclosure may further include operation S608 of forming a protrusion.

In operation S608 of forming the protrusion, a protrusion (308 of FIG. 3) may be formed in the other side of the radome material (302 of FIG. 3) facing between the position (P1 of FIG. 3) from which the transmission signal is transmitted and the position (P2 of FIG. 3) at which the reception signal is received, among the sides of the radome material (302 of FIG. 3).

Operation S608 of forming the protrusion may be performed after operation S604 of forming the depression. Alternatively, operation S608 of forming the protrusion may be performed simultaneously with operation S604 of forming the depression.

For example, in operation S608 of forming the protrusion, the protrusion (308 of FIG. 3) may be formed in a curved shape.

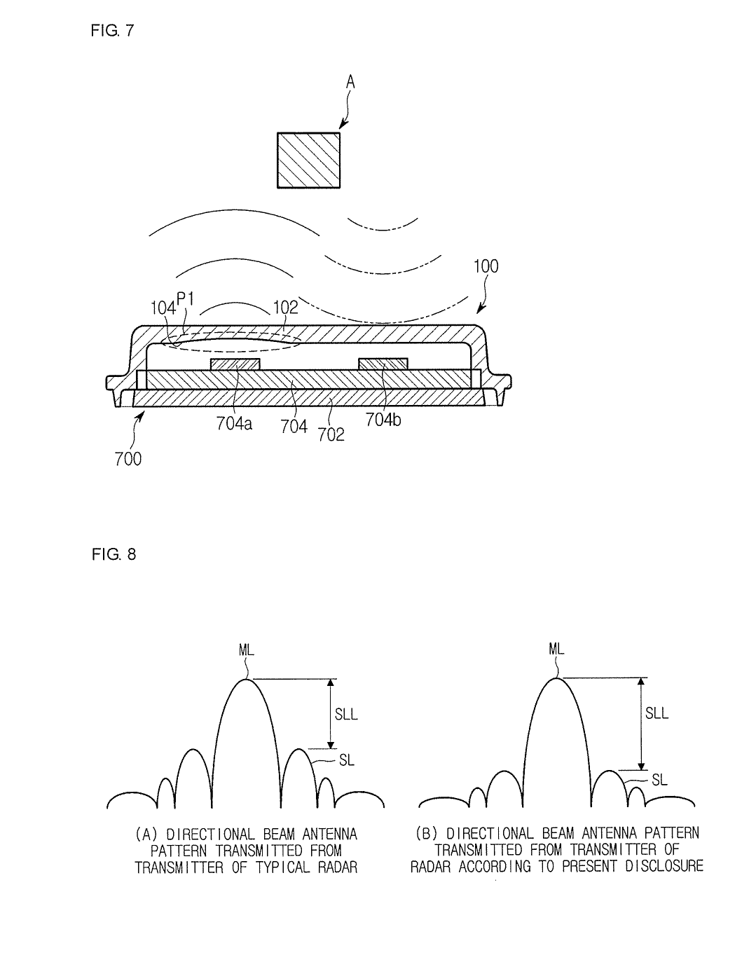

Hereinafter, a radar including the radome 100 according to an embodiment of the present disclosure will be described with reference to FIGS. 7 to 10.

FIG. 7 is a cross-sectional view showing an example of a radar including a radome according to an embodiment of the present disclosure, and FIG. 8 shows a directional beam antenna pattern transmitted from a transmitter of a typical radar, and a directional beam antenna pattern transmitted from a transmitter of a radar according to the present disclosure.

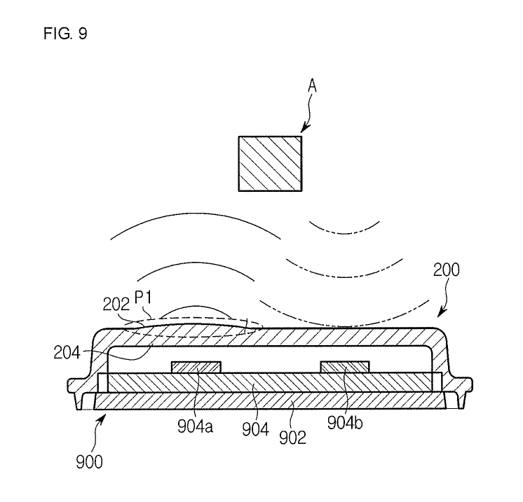

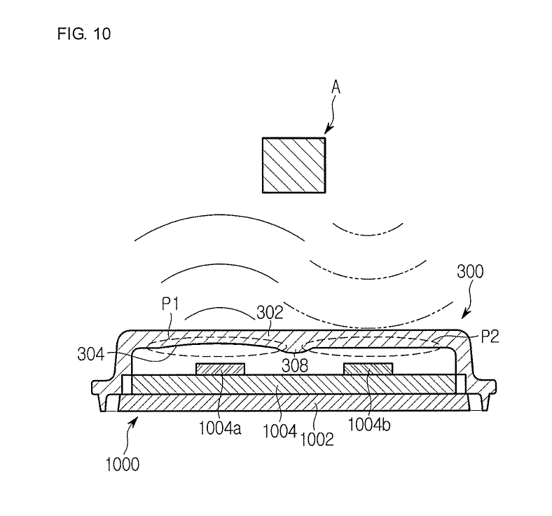

FIG. 9 is a cross-sectional view showing another example of a radar including a radome according to an embodiment of the present disclosure, and FIG. 10 is a cross-sectional view showing another example of a radar including a radome according to an embodiment of the present disclosure.

Referring to FIGS. 7 to 10, a radar 700, 900, and 100 including the radome 100 to 300 according to an embodiment of the present disclosure may include a body 702, 902, and 1002, a Printed Circuit Board (PCB) 704, 904, and 1004, and the radome 100 to 300.

The PCB 704, 904, and 1004 may be mounted on the body 702, 902, and 1002, and include a transmitter 704a, 904a, and 1004a that transmits a transmission signal for sensing an object A and a receiver 704b, 904b, and 1004b that receives a reception signal for sensing the object A.

The transmitter 704a, 904a, and 1004a may be a TX Chip module (not shown), and the receiver 704b, 904b, and 1004b may be a RX Chip module (not shown).

The receiver 704b, 904b, and 1004b may receive a reception signal for a reflective wave of a transmission signal.

The radome 100 to 300 may include a depression 104 to 304 formed in a side of the radome material 102 to 302 facing the position P1 from which the transmission signal is transmitted, among the sides of the radome material 102 to 302 coupled with the body 702, 902, and 1002 and configured to prevent the transmission signal and the reception signal from being damaged.

For example, the depression 104 to 304 may be formed in a curved shape.

As shown in FIGS. 7 and 8, since the radar 700 including the radome 100 according to an embodiment of the present disclosure includes the depression 104, the radar 700 may increase a side lobe level SLL between a main-lobe ML and side-lobes SL of a directional beam antenna pattern, compared to that of a directional beam antenna pattern transmitted from a transmitter of a typical radar, thereby minimizing signal interference due to the side-lobes SL while maximizing the main-lobe ML.

As shown in FIG. 9, a depression 206 may be further formed in the other side of the radome material 202 facing the position P2 at which the reception signal is received, among the sides of the radome material 202.

For example, the depression 206 may be formed in a curved shape.

As shown in FIG. 10, a radar 1000 including the radome 300 according to an embodiment of the present disclosure may further include a protrusion 308.

The protrusion 308 may be formed in the other side of the radome material 302 facing between the position P1 from which the transmission signal is transmitted and the position P2 at which the reception signal is received, among the sides of the radome material 302.

For example, the protrusion 308 may be formed in a curved shape.

The radar 700, 900, and 1000 including the radome 100 to 300 according to an embodiment of the present disclosure may be a vehicle radar, and use a wireless signal of a 77 GHz frequency band.

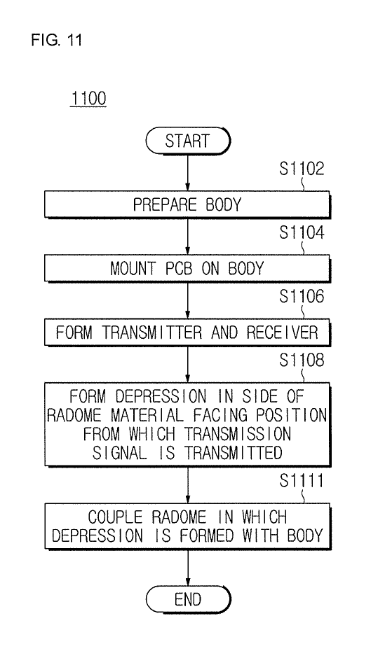

Hereinafter, a method of manufacturing the radar 700, 900, and 1000 including the radome 100 to 300 according to an embodiment of the present disclosure will be described with reference to FIGS. 11 to 13.

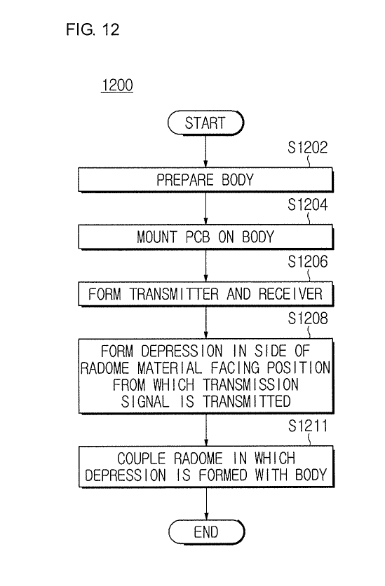

FIG. 11 is a flowchart illustrating an example of a radar manufacturing method according to an embodiment of the present disclosure, and FIG. 12 is a flowchart illustrating another example of a radar manufacturing method according to an embodiment of the present disclosure.

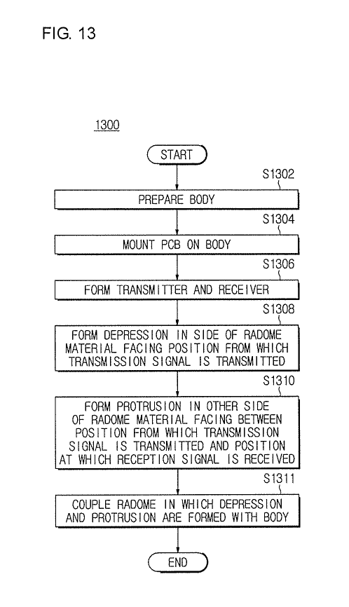

FIG. 13 is a flowchart illustrating another example of a radar manufacturing method according to an embodiment of the present disclosure.

Referring to FIGS. 11 to 13, a radar manufacturing method 1100 to 1300 according to an embodiment of the present disclosure may include first operation S1102 to S1302, second operation S1104 to S1304, third operation S1106 to S1306, fourth operation S1108 to S1308, and fifth operation S1111 to S1311.

First, in first operation S1102 to S1302, a body (702, 902, and 1002 of FIGS. 7, 9, and 10) may be prepared, and in second operation S1104 to S1304, a PCB (704, 904, and 1004 of FIGS. 7, 9, and 10) may be mounted on the body (702, 902, and 1002 of FIGS. 7, 9, and 10).

Thereafter, in third operation (S1106 to S1306), a transmitter (704a, 904a, and 1004a of FIGS. 7, 9, and 10) for transmitting a transmission signal for sensing an object (A of FIGS. 7, 9, and 10) may be formed on a side of the PCB (704, 904, and 1004 of FIGS. 7, 9, and 10), and a receiver (704b, 904b, and 1004b of FIGS. 7, 9, and 10) for receiving a reception signal for sensing the object (A of FIGS. 7, 9, and 10) may be formed on the other side of the PCB (704, 904, and 1004 of FIGS. 7, 9, and 10).

Thereafter, in fourth operation S1108 to S1308, a depression (104, 204, and 304 of FIGS. 7, 9, and 10) may be formed in a side of a radome material (102, 202, and 302 of FIGS. 7, 9, and 10) facing the position (P1 of FIGS. 7, 9, and 10) from which the transmission signal is transmitted, among the sides of the radome material (102, 202, and 302 of FIGS. 7, 9, and 10) for preventing a transmission signal and a reception signal from being damaged.

Since the radar manufacturing method 1100 according to an embodiment of the present disclosure forms the depression (104 of FIG. 7), the radar manufacturing method 1100 may increase a side lobe level (SLL of FIG. 8) between a main-lobe (ML of FIG. 8) and side-lobes (SL of FIG. 8) of a directional beam antenna pattern, compared to that of a directional beam antenna pattern transmitted from a transmitter of a typical radar, thereby minimizing signal interference due to the side-lobes (SL of FIG. 8) while maximizing the main-lobe (ML of FIG. 8).

As shown in FIG. 12, in third operation S1208, a protrusion may be formed in the other side of the radome material facing the position P1 from which the transmission signal is transmitted, among the sides of the radome material (202 of FIG. 9).

As shown in FIG. 13, in fourth operation S1310, a protrusion (308 of FIG. 10) may be further formed in the other side of the radome material (302 of FIG. 10) facing between the position (P1 of FIG. 10) from which the transmission signal is transmitted and a position (P2 of FIG. 10) at which a reception signal is received, among the sides of the radome material (302 of FIG. 10).

In fourth operation S1310, a depression (304 of FIG. 10) may be formed in the side of the radome material (302 of FIG. 10) facing the position (P1 of FIG. 10) from which the transmission signal is transmitted, in operation S1308, and then, a protrusion (308 of FIG. 10) may be further formed in the other side of the radome material (302 of FIG. 10) facing between the position (P1 of FIG. 10) from which the transmission signal is transmitted and the position (P2 of FIG. 10) at which the reception signal is received.

In fourth operation S1310, although not shown, a depression (304 of FIG. 10) may be formed in the side of the radome material (302 of FIG. 10) facing the position (P1 of FIG. 10) from which the transmission signal is transmitted, in operation S1308, and simultaneously, a protrusion (308 of FIG. 10) may be further formed in the other side of the radome material (302 of FIG. 10) facing between the position (P1 of FIG. 10) from which the transmission signal is transmitted and the position (P2 of FIG. 10) at which the reception signal is received.

For example, in fourth operation S1310, the protrusion (308 of FIG. 10) may be formed in a curved shape.

Thereafter, in fifth operation S1111, the radome (100 of FIG. 7) in which the depression (104 of FIG. 7) is formed may be coupled with the body (702 of FIG. 7).

As shown in FIG. 12, in fifth operation S1211, the radome (200 of FIG. 9) in which the depressions (204 and 206 of FIG. 10) are formed may be coupled with the body (902 of FIG. 9).

As shown in FIG. 13, in fifth operation S1311, the radome (300 of FIG. 10) in which the depression (304 of FIG. 10) and the protrusion (308 of FIG. 10) are formed may be coupled with the body (1002 of FIG. 10).

As such, since the radome 100, the radome manufacturing method 400, the radar 700 including the radome 100, and the radar manufacturing method 1100, according to an embodiment of the present disclosure, include the depression 104, it is possible to increase a side lobe level SLL between a main-lobe ML and side-lobes SL of a directional beam antenna pattern transmitted from the transmitter 704a, thereby minimizing signal interference due to the side-lobes SL while maximizing the main-lobe ML.

Also, since the radome 200, the radome manufacturing method 500, the radar 900 including the radome 200, and the radar manufacturing method 1200, according to another embodiment of the present disclosure, include the depressions 204 and 206, it is possible to increase a side lobe level SLL between a main-lobe ML and side-lobes SL of a directional beam antenna pattern transmitted from the transmitter 904a and the receiver 904b, thereby further minimizing signal interference due to the side-lobes SL while further maximizing the main-lobe ML.

Also, since the radome 300, the radome manufacturing method 600, the radar 1000 including the radome 300, and the radar manufacturing method 1300, according to another embodiment of the present disclosure, include the depression 304 and the protrusion 308, it is possible to further increase a side lobe level SLL between a main-lobe ML and side-lobes SL of a directional beam antenna pattern transmitted from the transmitter 1004a, thereby further minimizing signal interference due to the side-lobes SL while further maximizing the main-lobe ML.

Therefore, the radome, the method of manufacturing the radome, the radar including the radome, and the method of manufacturing the radar, according to the embodiments of the present disclosure, may minimize signal interference due to side-lobes while maximizing a main-lobe.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A radome for a radar sensor in a vehicle comprising:
a radome configured to a first region to penetrate a transmission signal and a second region to penetrate a reception signal; and
a depression formed in a side of the radome facing a position from which the transmission signal is transmitted, among sides of the radome.

2. A radome for a radar sensor in a vehicle comprising:
a radome configured to a first region to penetrate a transmission signal and a second region to penetrate a reception signal; and
a protrusion formed in the other side of the radome facing a position from which the transmission signal is transmitted, among sides of the radome.

3. The radome for a radar sensor in a vehicle of claim 1, further comprising a protrusion formed in the other side of the radome facing between the position from which the transmission signal is transmitted and a position at which the reception signal is received, among the sides of the radome.

4. The radome for a radar sensor in a vehicle of claim 1, wherein the depression is formed in a curved shape.

5. The radome for a radar sensor in a vehicle of claim 2, wherein the protrusion is formed in a convex shape.

6. A method of manufacturing a radome, comprising:
preparing a radome configured to prevent a transmission signal and a reception signal from being damaged; and
forming a depression in a side of the radome facing a position from which the transmission signal is transmitted, among sides of the radome.

7. A radar sensor in a vehicle comprising a radome, wherein the radome comprises:
a body;
a Printed Circuit Board (PCB) mounted on the body, and including a transmitter configured to transmit a transmission signal for sensing an object, and a receiver configured to receive a reception signal for sensing the object;
a radome material coupled with the body and configured to prevent the transmission signal and the reception signal from being damaged; and
a depression formed in a side of the radome material facing a position from which the transmission signal is transmitted, among sides of the radome material.

8. A radar sensor in a vehicle comprising a radome, wherein the radome comprises:
a body;
a Printed Circuit Board (PCB) mounted on the object, and including a transmitter configured to transmit a transmission signal for sensing an object, and a receiver configured to receive a reception signal for sensing the object;
a radome material; and
a protrusion formed in the other side of the radome material facing between a position from which the transmission signal is transmitted and a position at which the reception signal is received, among sides of the radome material.

9. The radar of claim 7, wherein the depression is formed in a curved shape.

10. The radar of claim 8, wherein the protrusion is formed in a convex shape.

11. A method of manufacturing a radar, comprising:
preparing a body;
mounting a Printed Circuit Board (PCB) on the body;
forming a transmitter configured to transmit a transmission signal for sensing an object, on a side of the PCB, and forming a receiver configured to receive a reception signal for sensing the object, on the other side of the PCB;
preparing a radome material configured to prevent the transmission signal and the reception signal from being damaged;
forming a depression in a side of the radome material facing a position from which the transmission signal is transmitted, among sides of the radome material; and
coupling the radome material in which the depression is formed, with the body.
